(19) United States
(12) Patent Application Publication
(10) Pub. No.: US 2016/0359329 A1
(43) Pub. Date: Dec. 8, 2016

(54) BATTERY CONTROL SYSTEM AND METHOD

(71) Applicant: SAMSUNG SDI CO., LTD., Yongin-si (KR)

(72) Inventors: Hwasu KIM, Yongin-si (KR); Inseob SONG, Yongin-si (KR); Cheolgi SON, Yongin-si (KR); Dongrak KIM, Yongin-si (KR); Kwangmin YOO, Yongin-si (KR); Hyunjun DO, Yongin-si (KR); Jeongkurn PARK, Yongin-si (KR); Sujun PARK, Yongin-si (KR); Jongrock CHOI, Yongin-si (KR); Junyoung KIM, Yongin-si (KR)

(21) Appl. No.: 15/164,050

(22) Filed: May 25, 2016

(30) Foreign Application Priority Data
Jun. 4, 2015 (KR) 10-2015-0079202

(51) Int. Cl. H02J 3/38; H02J 7/00; H02M 7/44; H02M 3/04; H02M 7/04

(52) U.S. Cl. CPC H02J 3/382; H02M 3/04; H02M 7/04; H02M 7/44; H02J 3/383; H02J 3/386; H02J 7/0068

(57) ABSTRACT

A battery control system includes a plurality of battery packs and a controller. The battery packs are connected in parallel to each other, and the controller and the battery packs are connected to a controller area network (CAN) communication line. Each battery pack transmits/receives identifiers of the battery packs through the CAN communication line to/from each other. A master battery pack and slave battery packs are determined according to priorities of the identifiers. The controller communicates with the master battery pack, and the master battery pack communicates with the slave battery packs.

### CROSS-REFERENCE TO RELATED APPLICATION

Korean Patent Application No. 10-2015-0079202, filed on Jun. 4, 2015, and entitled, “Battery Control System and Method,” is incorporated by reference herein in its entirety.

### BACKGROUND

1. Field

One or more embodiments herein relate to a battery control system and method.

2. Description of the Related Art

Environmental destruction and resource depletion continues to be a concern. As a result, there is a growing interest in systems that store energy efficiently, and especially ones that do so without causing pollution. A variety of energy storage systems have been developed. Some store surplus electricity (e.g., generated by wind power or sunlight) in batteries. When electrical loads consume peak power or when electrical grids experience errors, the electricity stored in the batteries may be applied to the grids to improve stability. Attempts have been made to apply this idea to electric vehicles.

### SUMMARY

In accordance with one or more embodiments, a battery control system includes a plurality of battery packs connected to a controller area network (CAN) communication line, the battery packs connected in parallel with each other; and a controller connected to the CAN communication line, wherein each of the battery packs is to transmit and receive identifiers of the battery packs through the CAN communication line to and from each other, wherein a master battery pack and slave battery packs are to be determined according to priorities of the identifiers, and wherein the controller is to communicate with the master battery pack and the master battery pack is to communicate with the slave battery packs.

Each battery pack may include a battery module including at least one battery cell; and a battery management system (BMS) to receive state information of the battery module and to transmit the state information and the identifier of the battery pack, in which the BMS is included, to another battery pack through the CAN communication line. The BMS may compare the identifier of the battery pack, in which the BMS is included, with the identifier of another battery pack to determine whether the battery pack, in which the BMS is included, is a master battery pack or a slave battery pack. The state information may include at least one of voltage, current, temperature, or state of charge information. The identifiers may be internal identifications of the battery packs.

Each battery pack may exchange the its own identifier with identifiers of the other battery packs through the CAN communication line for a preset time period after being powered on, and a master battery pack and slave battery packs may be determined according to the priorities of the identifiers. The master battery pack may receive state information of the slave battery packs from the slave battery packs, and the controller may receive the state information of the slave battery packs and state information of the master battery pack from the master battery pack.

The master battery pack may receive control commands from the controller, and the slave battery packs may receive the control commands from the master battery pack. One of the battery packs having an identifier of highest priority may be determined as a master battery pack, and the other battery packs may be determined as slave battery packs. The controller and the battery packs may communicate with each other using CAN IDs, and a CAN ID to be used for communication between the controller and the master battery pack may be different from CAN IDs to be used for communication between the master battery pack and the slave battery packs.

In accordance with one or more other embodiments, a battery control method includes applying power to a plurality of battery packs; exchanging identifiers of the battery packs through a controller area network (CAN) communication line for a preset time period after power is applied to the battery packs; determining a master battery pack and slave battery packs according to priorities of the identifiers; and controlling the master battery pack and the slave battery packs according to control commands respectively received from the controller and the master battery pack.

Determining the master battery pack and the slave battery packs may includes determining one of the battery packs having an identifier of the highest priority as a master battery pack and the other battery packs as slave battery packs. Controlling the master battery pack and the slave battery packs may include transmitting control commands from a controller to the master battery pack, and transmitting control commands from the master battery pack to the slave battery packs. The identifiers may be internal IDs of the battery packs.

Each battery pack may include a battery module including at least one battery cell, a battery management system (BMS) to receive state information of the battery module and to transmit the state information and the identifier of the battery pack, in which the BMS is included, to another battery pack through the CAN communication line, and exchanging of the identifiers of the battery packs is performed by the BMSs of the battery packs.

Determining the master battery pack and the slave battery packs may include comparing, by the BMS of each battery pack, the identifier of the battery pack, in which the BMS is included, with the identifier of another battery pack to determine whether the battery pack, in which the BMS is included, is a master or slave battery pack.

Controlling the master battery pack and the slave battery packs may include transmitting state information of the slave battery packs from the slave battery packs to the master battery pack, and transmitting the state information of the slave battery packs and state information of the master battery pack from the master battery pack to the controller. The state information may include at least one of voltages, currents, temperatures, or SOCs of the battery packs.

Controlling the master battery pack and the slave battery packs may include establishing communications between a controller and the battery packs using CAN IDs, wherein a CAN ID used for communication between the controller and the master battery pack is different from CAN IDs used for communication between the master battery pack and the slave battery packs.

### BRIEF DESCRIPTION OF THE DRAWINGS

Features will become apparent to those of skill in the art by describing in detail exemplary embodiments with reference to the attached drawings in which:

FIG. 1 illustrates an example of an energy storage system;

FIG. 2 illustrates an embodiment of a battery control system;

FIG. 3 illustrates an embodiment of battery packs of the battery control system;

FIG. 4 illustrates an example of communication between master and slave battery packs;

FIG. 5 illustrates an example of priorities of master and slave battery packs;

FIG. 6 illustrates an embodiment for determining master and slave battery packs; and

FIG. 7 illustrates an embodiment of a battery control method.

### DETAILED DESCRIPTION

Example embodiments are described more fully hereinafter with reference to the drawings; however, they may be embodied in different forms and should not be construed as limited to the embodiments set forth herein. Rather, these embodiments are provided so that this disclosure will be thorough and complete, and will fully convey exemplary implementations to those skilled in the art. The embodiments may be combined to form additional embodiments.

It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

When an element is referred to as being “connected” or “coupled” to another element, it can be directly connected or coupled to the another element or be indirectly connected or coupled to the another element with one or more intervening elements interposed therebetween. In addition, when an element is referred to as “including” a component, this indicates that the element may further include another component instead of excluding another component unless there is different disclosure.

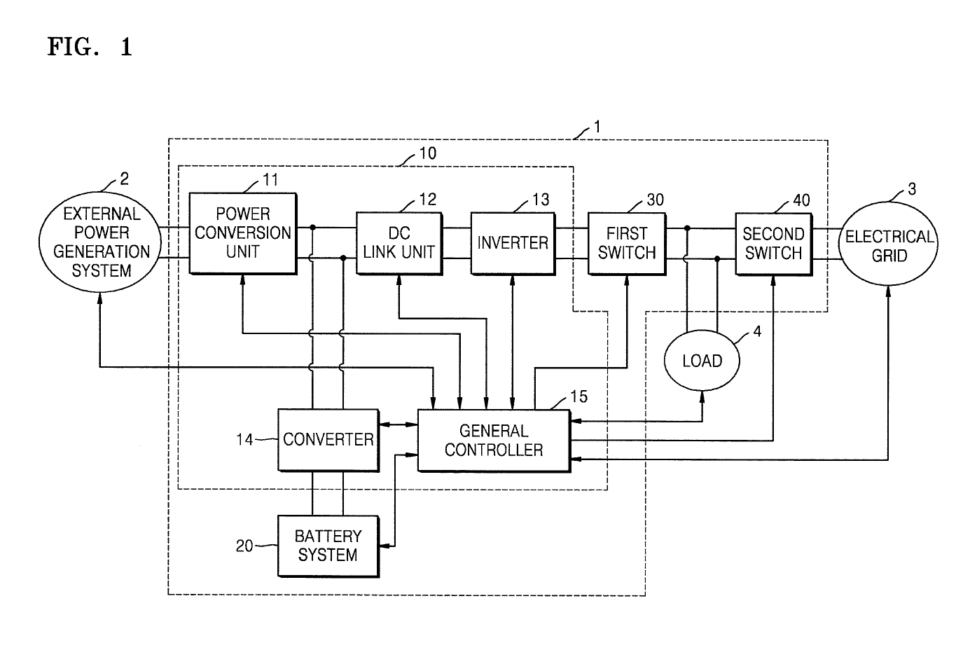

FIG. 1 illustrates an example of an energy storage system 1 for supplying power to an external load 4. The energy storage system is connected to an external power generation system 2 and an electrical grid 3.

The power generation system 2 generates electricity using an energy source and supplies the electricity to the energy storage system 1. The power generation system 2 may include one or more solar power generation systems, wind power generation systems, tidal power generation systems, and/or other types of power generation systems, including but not limited to systems that regenerate energy from, for example, solar or geothermal heat. In one embodiment, the power generation system 2 may be a solar battery system capable of generating electricity using sunlight, and the energy storage system 1 may be installed in a home or plant. The power generation system 2 may include a plurality of power generation modules connected in parallel to function as a large-capacity energy system.

The electrical grid 3 may include power plants, substations, transmission lines, etc. When the electrical grid 3 is in a normal state, the electrical grid 3 may supply electricity to the energy storage system 1. For example, the electrical grid 3 may supply electricity to at least one of the load 4 or a battery system 20. The electrical grid 3 may receive electricity from the energy storage system 1, e.g., from the battery system 20. When the electrical grid 3 is in an abnormal state, electricity may not be transmitted between the electrical grid 3 and the energy storage system 1.

The load 4 consumes electricity generated by the power generation system 2, stored in the battery system 20, and/or supplied from the electrical grid 3. For example, the load 4 may correspond to electric devices, for example, in a home or plant.

Electricity generated by the power generation system 2 may be stored in the battery system 20 and/or supplied to the electrical grid 3 by the energy storage system 1. The energy storage system 1 may supply electricity stored in the battery system 20 to the electrical grid 3 or may store electricity from the electrical grid 3 in the battery system 20. In addition, the energy storage system 1 may supply electricity, generated by the power generation system 2 and/or stored in the battery system 20, to the load 4. When the electrical grid 3 is in an abnormal state (e.g., a blackout state), the energy storage system 1 may function as an uninterruptible power supply (UPS) that supplies electricity generated by the power generation system 2 or stored in the battery system 20 to load 4.

The energy storage system 1 includes a power conversion system (PCS) 10, the battery system 20, a first switch 30, and a second switch 40. The PCS 10 converts electricity supplied from the power generation system 2, the electrical grid 3, and the battery system 20 to electricity of a proper type. The converted electricity is supplied to sites or devices requiring electricity.

The PCS 10 includes a power conversion unit 11, a direct current (DC) link unit 12, an inverter 13, a converter 14, and a general controller 15. The power conversion unit 11 is connected between the power generation system 2 and the DC link unit 12. The power conversion unit 11 converts electricity generated by the power generation system 2 to a DC link voltage, and the DC link voltage is applied to the DC link unit 12.

According to the type of the power generation system 2, the power conversion unit 11 may include a power conversion circuit such as a converter circuit or a rectifier circuit. For example, if the power generation system 2 generates DC electricity, the power conversion unit 11 may include a DC-DC converter to convert DC electricity generated by the power generation system 2 to DC electricity of a different type. If the power generation system 2 generates alternating current (AC) electricity, the power conversion unit 11 may include a rectifier circuit to convert AC electricity to DC electricity.

In one exemplary embodiment, the power generation system 2 may be a solar power generation system. In this case, the power conversion unit 11 may include a maximum power point tracking (MPPT) converter to maximally receive electricity from the power generation system 2 according to various factors, such as the amount of solar radiation or temperature. When the power generation system 2 does not generate electricity, the power conversion unit 11 may not be operated in order to minimize consumption of power by the power conversion circuit, such as a converter circuit or a rectifier circuit.

The general controller 15 monitors the states of the power generation system 2, the electrical grid 3, the battery system 20, and/or the load 4. For example, the general controller 15 may monitor whether the electrical grid 3 is in a blackout state, whether the power generation system 2 generates electricity, the amount of electricity generated by the power generation system 2, the state of charge (SOC) of the battery system 20, and/or the amount of power consumption or operation time of the load 4.

The general controller 15 controls the power conversion unit 11, the inverter 13, the converter 14, the battery system 20, the first switch 30, and the second switch 40 according to results of monitoring and a preset algorithm. For example, if the electrical grid 3 is in a blackout state, electricity stored in the battery system 20 or generated by the power generation system 2 may be supplied to the load 4 under the control of the general controller 15. If sufficient electricity is not supplied to the load 4, the general controller 15 may determine priorities of the electric devices of the load 4, and may control the load 4 so that electricity is first supplied to higher priority devices. The general controller 15 may control charging and discharging operations of the battery system 20.

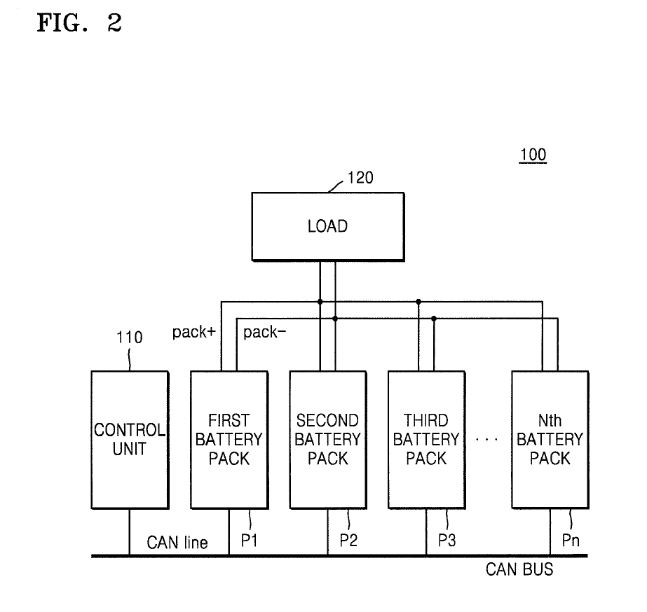

FIG. 2 illustrating an embodiment of a battery control system 100 which includes a control unit 110 and a plurality of battery packs, e.g., first to nth battery packs P1 to Pn, connected in parallel to a controller area network (CAN) communication line.

The battery packs supply electricity to a load 120 and may be turned on or off according to control commands of the control unit 110. The battery packs such as the first to nth battery packs P1 to Pn are connected to a CAN BUS through CAN lines. The control unit 110 is also connected to the CAN BUS through a CAN line. In one embodiment, the CAN communication line may include a plurality of CAN lines corresponding to the CAN BUS in FIG. 2.

The battery packs transmit/receive corresponding identifiers through the CAN communication line to/from each other. For example, the first battery pack P1 may transmit its identifier to the second to nth battery packs P2 to Pn, and may receive the identifiers of the second to nth battery packs P2 to Pn. The second battery pack P2 may transmit its identifier to the first battery pack P1 and the third to nth battery packs P3 to Pn, and may receive the identifiers of the first battery pack P1 and the third to nth battery packs P3 to Pn. The other battery packs may transmit and receive their identifiers in the same manner.

Each battery pack compares the priority of its identifier with priorities of the identifiers of the other battery packs, and determines a master battery pack and slave battery packs according to results of the comparison. For example, if the priority of the identifier of the first battery pack P1 is higher than the priorities of the identifiers of the other battery packs, the first battery pack P1 is determined as a master battery pack and the other battery packs are determined as slave battery packs.

Then, the control unit 110 communicates with the master battery pack, and the master battery pack communicates with the slave battery packs. In the above-mentioned example, the control unit 110 communicates with the first battery pack P1 determined as a master battery pack, and the first battery pack P1 communicates with the other battery packs determined as slave battery packs.

For example, a battery pack determined as a master battery pack directly communicates with the control unit 110, and battery packs determined as slave battery packs communicate with the master battery pack but do not directly communicate with the control unit 110. The master battery pack receives control commands (or control command signals) from the control unit 110 and transmits the control commands to the slave battery packs.

The slave battery packs transmit their state information to the master battery pack, and the master battery pack transmits the state information of the slave battery packs and its state information to the control unit 110.

After being powered on, each of the battery packs may exchange their identifiers through the CAN communication line for a preset time period. When a new battery pack is added or an existing battery pack is removed, and/or when all the battery packs are powered off and then powered on, each of the battery packs receives the identifiers of the other battery packs and compares the priority of its own identifier with the priorities of the identifiers of the other battery packs.

Each identifier of the battery packs may include, for example, a series of digits. In one embodiment, the identifiers may have the same number of digits to allow for easier comparison of the identifiers. Each battery pack may sort its identifier and the identifiers of the other battery packs according to the sizes of the identifiers, and may determine whether the battery pack is a master battery pack or a slave battery pack according to results of the sorting. For example, a battery pack having an identifier of the highest priority may be determined as a master battery pack, and the other battery packs may be determined as slave battery packs.

Examples of state information of the battery packs provided to the control unit 110 from the master battery pack include voltages, currents, temperatures, and SOCs of the battery packs. The control unit 110 outputs control commands for respectively controlling the battery packs according to the state information of the battery packs. The control commands may be provided to the master battery pack, and the master battery pack may deliver the control commands to the slave battery packs.

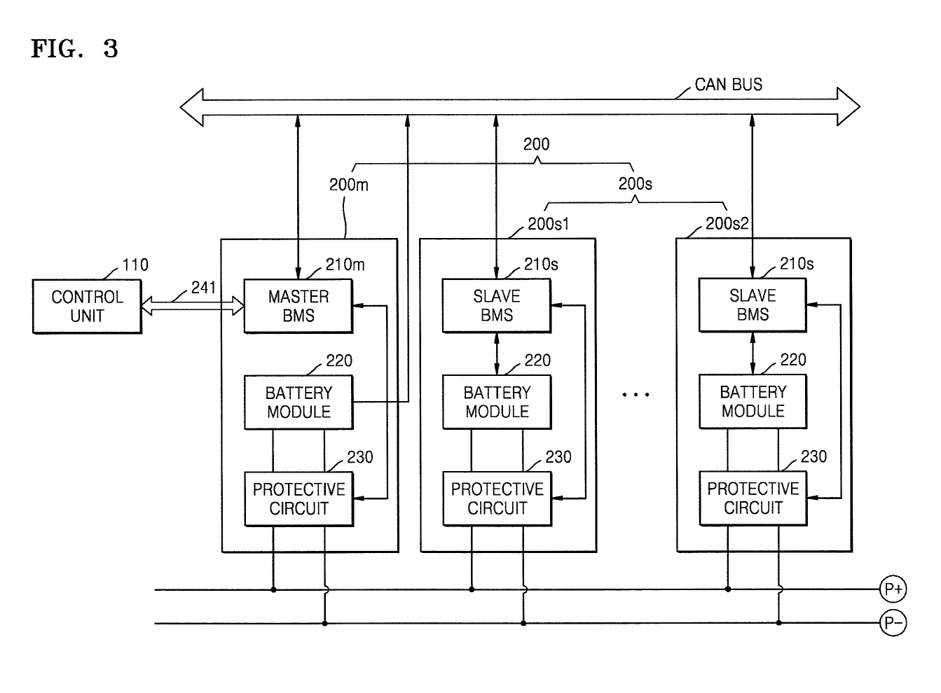

FIG. 3 illustrates an embodiment which includes battery packs 200 of the battery control system 100. Referring to FIG. 3, each battery pack 200 includes a battery module 220 and a battery management system (BMS) 210m or 210s. The battery packs 200 are connected to a CAN BUS through CAN lines. The battery pack 200 located at the first position from the left side is a master battery pack 200m in directly communication with a control unit 110. (In at least one embodiment, the CAN BUS and the CAN lines may be collectively referred to as a CAN communication line 241). For clarity of description, the BMS of the master battery pack 200m will be referred to as a master BMS 210m. Other battery packs 200 may be slave battery packs 200s, and the BMSs of the slave battery packs 200s will be referred to as slave BMSs 210s.

In FIG. 3, one master battery pack 200m and two slave battery packs 200s1 and 200s2 are illustrated for clarity of description. However, a different number of (e.g., three or more) slave battery packs may be provided.

In a given battery pack 200, the battery module 220 includes at least one battery cell. The BMS 210m or 210s receives state information of the battery module 220 and transmits the state information and an identifier of the given battery pack 200 to another battery pack 200 through the CAN communication line 241. The state information may include voltage, current, temperature, and/or SOC of the given battery pack 200. For example, the state information may include the voltage, current, temperature, and/or SOC of the battery module 220.

The BMS 210m or 210s compares the priority of the identifier of another battery pack 200 with the priority of the identifier of its own battery pack 200. Based on this comparison, the BMS 210m or 210s determines whether its own battery pack 200 is a master battery pack 200m or a slave battery pack 200s.

The battery packs 200 are connected in parallel. When the battery packs 200 are powered on, the BMSs 210m and 210s of the battery packs 200 may exchange identifiers with each other for a preset time period. For example, the master BMS 210m may transmit an identifier of the master battery pack 200m, in which the master BMS 210m is included, to the slave BMSs 210s in the slave battery packs 200s, and may receive identifiers of the slave battery packs 200s from the slave BMSs 210s.

Each of the master BMS 210m and the slave BMS 210s compare the identifier of the battery pack 200, in which the BMS 210m or 210s is included, with the identifier of the other battery packs 200. Based on this comparison, master battery pack 200m and slave battery packs 200s are determined according to the priorities of the identifiers.

In one embodiment, the priority of the identifier of the master battery pack 200m is higher than the priorities of the identifiers of the other battery packs 200, and thus the master battery pack 200m is determined as the master.

The battery packs 200 may further include protective circuits 230. The BMSs 210m and 210s control the protective circuits 230 in order to protect the battery packs 200 in an abnormal state. For example, if an abnormal situation (e.g., overcurrent or overcharged) occurs, the BMSs 210m and 210s may open switches of the protective circuits 230 to interrupt power transmission between the battery modules 220 and input/output terminals P+ and P−. The BMSs 210m and 210s monitor and measure states of the battery modules 220 such as temperatures, voltages, or currents of the battery modules 220. The BMSs 210m and 210s may control balancing of the battery cells of the battery modules 220 according to data obtained from the measurement and a preset algorithm.

The battery modules 220 store electricity supplied from a power generation system and/or an electrical grid, and supplies the electricity to the electrical grid or a load. The switches of the protective circuits 230 may be turned on or off under the control of the BMSs 210m and 210s, in order to supply electricity or interrupt supply of electricity to the battery modules 220. For example, the protective circuits 230 may provide information (e.g., output voltages or currents of the battery module 220, switch states, and/or fuse states) to the BMSs 210m and 210s.

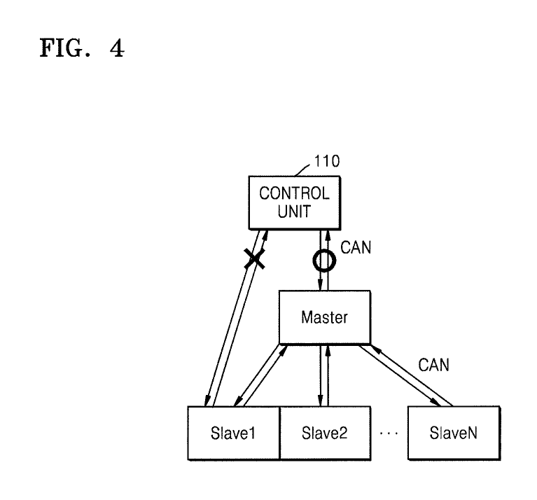

FIG. 4 illustrates an example of the communication that may take place between a master battery pack and slave battery packs of a battery control system. Referring to FIG. 4, the battery control system includes a master battery pack Master and N slave battery packs Slave 1 to Slave N. Like the battery control systems described with reference to FIGS. 2 and 3, the battery control system includes a control unit 110. The battery control system may further include an electrical grid supplying electricity to the battery control system and/or a load receiving electricity from the battery control system.

The master battery pack Master communicates with the control unit 110 and the slave battery packs Slave 1 to Slave N through a CAN communication line, receives state information of the slave battery packs Slave 1 to Slave N, and delivers the state information to the control unit 110. In addition, the master battery pack Master may transmit its own state information to the control unit 110.

The master battery pack Master receives control commands from the control unit 110 and transmits the control commands to the slave battery packs Slave 1 to Slave N. As shown in FIG. 4, in this embodiment, the slave battery packs Slave 1 to Slave N do not directly communicate with the control unit 110. Also, control commands for controlling the slave battery packs Slave 1 to Slave N are transmitted from the control unit 110 to the slave battery packs Slave 1 to Slave N through the master battery pack Master.

Also, in this embodiment, state information of the slave battery packs Slave 1 to Slave N are not directly transmitted to the control unit 110, but is indirectly transmitted to the control unit 110 through the master battery pack Master. In this case, control commands and state information may be transmitted using different CAN identifications (IDs) between the control unit 110 and the master battery pack Master and between the master battery pack Master and the slave battery packs Slave 1 to Slave N.

A dedicated CAN ID may be set for communication between the control unit 110 and master battery pack Master, and different CAN IDs may be set for communication between the master battery pack Master and slave battery packs Slave 1 to Slave N. After the master battery pack Master and the slave battery packs Slave 1 to Slave N are determined according to their priorities, the battery packs communicate with each other using CAN IDs respectively set for the master battery pack Master and the slave battery packs Slave 1 to Slave N. In this case, the master battery pack Master does not use a CAN ID given thereto for communication with the control unit 110, but uses a different CAN ID set for communication with the slave battery packs Slave 1 to Slave N. The slave battery packs Slave 1 to Slave N do not use the CAN ID used for communication between the master battery pack Master and the control unit 110, but use different CAN IDs respectively set for the slave battery packs Slave 1 to Slave N according to their priorities for communication with the master battery pack Master.

As described above, in this embodiment, different CAN IDs are set according to the relationship between the battery packs. Therefore, communication among the control unit 110, the master battery pack Master, and the slave battery packs Slave 1 to Slave N may be automatically separated for preventing interference.

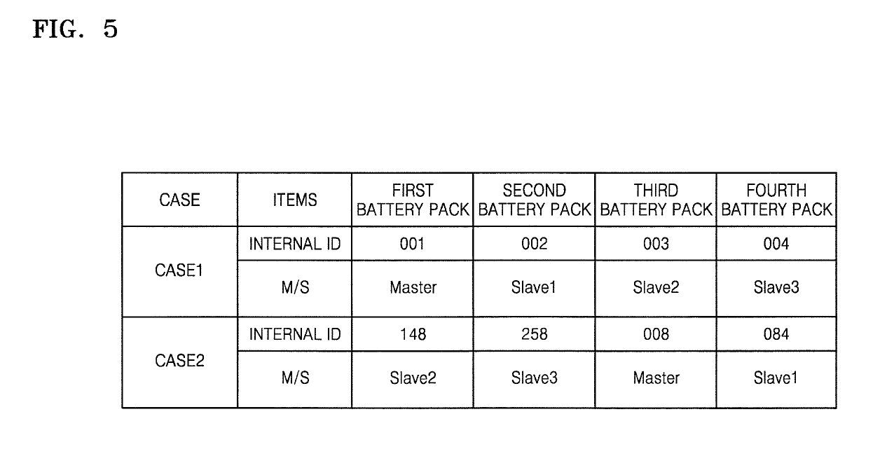

FIG. 5 illustrates a table illustrating an embodiment of how a master battery pack and slave battery packs are determined according to priorities of identifiers. Referring to FIG. 5, the table provides information indicative of a battery system which includes four battery packs (first to fourth battery packs) with respective internal IDs.

In CASE 1, the identifiers (that is, the internal IDs) of the first to fourth battery packs are 001, 002, 003, and 004, respectively. According to the priorities of the internal IDs, the first battery pack is determined as a master battery pack. However, if an algorithm allocating a higher priority to a greater internal ID is used, the fourth battery pack may be determined as a master battery pack and the other battery packs may be determined as slave battery packs.

In CASE 2, the identifiers (that is, the internal IDs) of the first to fourth battery packs are 148, 258, 008, and 084, respectively. According to the priorities of the internal IDs, the third battery pack is determined as a master battery pack. However, if an algorithm allocating a higher priority to a greater internal ID is used, the second battery pack may be determined as a master battery pack and the other battery packs may be determined as slave battery packs.

Internal IDs may be unique numbers allocated to battery packs, for example, when the battery packs are manufactured. In one embodiment, no two battery packs may have the same internal ID. If there are battery packs having the same internal ID, information other than internal IDs may be used as identifiers. For example, numbers, letters, or combinations of numbers and letters may be allocated to battery packs of a battery system, where the numbers, letters, or combinations of numbers and letters are used as identifiers. In this case, numbers, letters, or combinations of numbers and letters, are allocated as identifiers to battery packs in such a manner that there will be no battery packs having the same identifier.

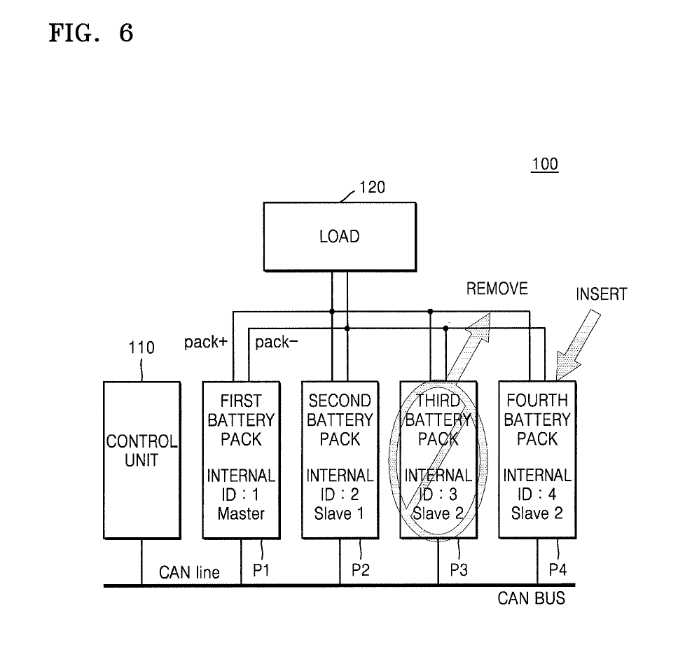

FIG. 6 illustrates an embodiment of processes for determining a master battery pack and slave battery packs when one or more battery packs are added or removed. Referring to FIG. 6, the battery control system 100 includes first to third battery packs P1 to P3. In this state, the third battery pack P3 is removed from the battery control system 100 and a fourth battery pack P4 is added to the battery control system 100.

When the battery control system 100 is first powered on, the first to third battery packs P1 to P3, which are connected in parallel, exchange their identifiers (or internal IDs) to determine a master battery pack and slave battery packs according to the priorities of the identifiers. In the example in FIG. 6, a smaller identifier has a higher priority. Thus, the first battery pack P1 is determined as a master battery pack and the second and third battery packs P2 and P3 are determined as slave battery packs.

When the third battery pack P3 is replaced, for example, because of errors or a malfunction, the first to third battery packs P1 to P3 are powered off and the third battery pack 3 is disconnected from the first and second battery packs P1 and P2. Then, a new battery pack (namely, fourth battery pack P4) is connected in parallel to the first and second battery packs P1 and P2, and the first, second, and fourth battery packs P1, P2, and P4 are powered on.

Then, the first, second, and fourth battery packs P1, P2, and P4 exchange their identifiers (or internal IDs). The identifier (or internal ID) of the fourth battery pack P4 is 4. Since a smaller identifier has a higher priority in this example, the first battery pack P1 is determined as a master battery pack as before and the fourth battery pack P4 is determined as a slave battery pack.

Then, the first battery pack P1 receives state information of the second and fourth battery packs P2 and P4. The state information is transmitted to a control unit 110. The first battery pack P1 receives control commands from the control unit 110 and transmits the control commands to the second and fourth battery packs P2 and P4. Furthermore, the first battery pack P1 transmits its state information to the control unit 110 and receives control commands from the control unit 110.

Control commands of the control unit 110 are provided for controlling the master battery pack and the slave battery packs. The control commands include, for example, commands for controlling connection of the master battery pack and the slave battery packs to input/output terminals.

The battery packs determined as a master battery pack may receive control commands for controlling the battery packs from the control unit 110 using a dedicated CAN ID that the master battery pack and the control unit 110 have indicated as an identifier of the master battery pack. At this time, since the other battery packs determined as slave battery packs use CAN IDs different from the dedicated CAN ID of the master battery pack, the slave battery packs may not directly receive the control commands from the control unit 110. Rather, the master battery pack may transmit the control commands received from the control unit 110 to the slave battery packs.

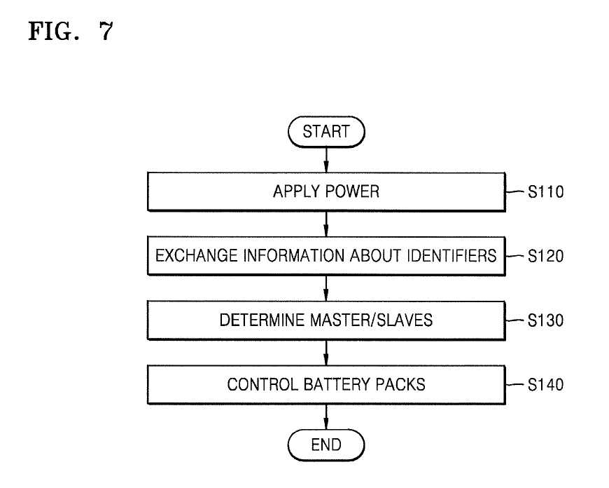

FIG. 7 illustrates an embodiment of a battery control method for controlling a system including a control unit and a plurality of battery packs connected in parallel to a CAN communication line. The battery control method includes applying power to the battery packs (operation S110); exchanging identifiers of the battery packs (operation S120); determining a master battery pack and slave battery packs (S130); and controlling the battery packs (operation S140).

In operation S120, the identifiers of the battery packs are exchanged through the CAN communication line for a preset time period after power is applied to the battery packs. The identifiers of the battery packs may be internal IDs of the battery packs. The internal IDs may be unique numbers respectively allocated to the battery packs, for example, when the battery packs are manufactured or at another time, e.g., when programmed by a user.

In operation S130, one of the battery packs is determined as a master battery pack, and one or more of the other battery packs are determined as slave battery packs according to the priorities of the identifiers. In one embodiment, a higher priority may be allocated to a smaller identifier or a greater identifier. The identifiers may have the same number of digits or letters to allow for easier comparison of the identifiers, for example, according to the size or order of the identifiers. Alternatively, each identifier may include a combination of digits and letters and/or other symbols.

In operation S140, the master battery pack and the slave battery packs are controlled according to control commands transmitted from the control unit and the master battery pack. Control commands from the control unit may include commands for controlling the master battery pack or the slave battery packs. Control commands from the control unit for controlling the slave battery packs are transmitted to the slave battery packs through the master battery pack.

Each battery pack may include a battery module including at least one battery cell, and a BMS to receive state information of the battery module and to transmit the state information to another battery pack through the CAN communication line. In operation S120, the identifiers of the battery packs may be exchanged by the BMSs of the battery packs.

The BMS of each battery pack has information about the identifier of the battery pack in which the BMS is included. After the battery packs are connected to each other and powered on, the BMS may transmit the identifier of the battery pack in which the BMS is included to the other battery packs for a preset time period. In addition, the BMS may receive the identifiers of the other battery packs from the BMSs of the other battery packs. The identifiers may be exchanged through the CAN communication line.

In operation S120, each BMS may compare the priority of the identifier of a battery pack in which the BMS is included with the priorities of the identifiers of the other battery packs, and may determine whether the battery pack in which the BMS is included is a master battery pack or a slave battery pack according to the priorities of the identifiers.

In operation S140, the master battery pack may receive state information of the slave battery packs from the slave battery packs. The control unit may receive the state information of the slave battery packs and state information of the master battery pack from the master battery pack. At this time, the master battery pack and the control unit may communicate with each other using a dedicated CAN ID in order to prevent the slave battery packs from communicating with the control unit.

The control unit outputs control commands for controlling the master battery pack and/or the slave battery packs. The control commands are transmitted to the master battery pack. When the control commands include control commands for controlling the slave battery packs, the master battery pack may transmit the control commands for controlling the slave battery packs to the slave battery packs. At this time, the master battery pack communicates with the slave battery packs using dedicated CAN IDs different from the dedicated CAN ID used for communication with the control unit. The state information may include voltages, currents, temperatures, and/or SOCs of the master battery pack and the slave battery packs.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing the methods described herein.

The controller, battery managements systems, and other processing features may be implemented in logic which, for example, may include hardware, software, or both. When implemented at least partially in hardware, the controller, battery managements systems, and other processing features may be, for example, any one of a variety of integrated circuits including but not limited to an application-specific integrated circuit, a field-programmable gate array, a combination of logic gates, a system-on-chip, a microprocessor, or another type of processing or control circuit.

When implemented in at least partially in software, the controller, battery managements systems, and other processing features may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods (or operations of the computer, processor, microprocessor, controller, or other signal processing device) are described in detail, the code or instructions for implementing the operations of the method embodiments may transform the computer, processor, controller, or other signal processing device into a special-purpose processor for performing the methods described herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, controller, or other signal processing device which is to execute the code or instructions for performing the method embodiments described herein.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the invention as set forth in the following claims.

What is claimed is:

1. A battery control system comprising:
a plurality of battery packs connected to a controller area network (CAN) communication line, the battery packs connected in parallel with each other; and
a controller connected to the CAN communication line, wherein each of the battery packs is to transmit and receive identifiers of the battery packs through the CAN communication line to and from each other, wherein a master battery pack and slave battery packs are to be determined according to priorities of the identifiers, and wherein the controller is to communicate with the master battery pack and the master battery pack is to communicate with the slave battery packs.

2. The system as claimed in claim 1, wherein each battery pack includes:
a battery module including at least one battery cell; and
a battery management system (BMS) to receive state information of the battery module and to transmit the state information and the identifier of the battery pack, in which the BMS is included, to another battery pack through the CAN communication line.

3. The system as claimed in claim 2, wherein the BMS is to compare the identifier of the battery pack, in which the BMS is included, with the identifier of another battery pack to determine whether the battery pack, in which the BMS is included, is a master battery pack or a slave battery pack.

4. The system as claimed in claim 2, wherein the state information includes at least one of voltage, current, temperature, or state of charge information.

5. The system as claimed in claim 1, wherein the identifiers are internal identifications of the battery packs.

6. The system as claimed in claim 1, wherein:
each battery pack is to exchange its own identifier with identifiers of the other battery packs through the CAN communication line for a preset time period after being powered on, and
a master battery pack and slave battery packs are to be determined according to the priorities of the identifiers.

7. The system as claimed in claim 1, wherein:
the master battery pack is to receive state information of the slave battery packs from the slave battery packs, and
the controller is to receive the state information of the slave battery packs and state information of the master battery pack from the master battery pack.

8. The system as claimed in claim 1, wherein:
the master battery pack is to receive control commands from the controller, and
the slave battery packs are to receive the control commands from the master battery pack.

9. The system as claimed in claim 1, wherein:
one of the battery packs having an identifier of highest priority is to be determined as a master battery pack, and
the other battery packs are to be determined as slave battery packs.

10. The system as claimed in claim 1, wherein:
the controller and the battery packs are to communicate with each other using CAN IDs, and
a CAN ID to be used for communication between the controller and the master battery pack is different from CAN IDs to be used for communication between the master battery pack and the slave battery packs.

11. A battery control method, the method comprising:
applying power to a plurality of battery packs;
exchanging identifiers of the battery packs through a controller area network (CAN) communication line for a preset time period after power is applied to the battery packs;
determining a master battery pack and slave battery packs according to priorities of the identifiers; and
controlling the master battery pack and the slave battery packs according to control commands respectively received from the controller and the master battery pack.

12. The method as claimed in claim 11, wherein determining the master battery pack and the slave battery packs includes:
determining one of the battery packs having an identifier of the highest priority as a master battery pack and the other battery packs as slave battery packs.

13. The method as claimed in claim 11, wherein controlling the master battery pack and the slave battery packs includes:
transmitting control commands from a controller to the master battery pack, and
transmitting control commands from the master battery pack to the slave battery packs.

14. The method as claimed in claim 11, wherein the identifiers are internal IDs of the battery packs.

15. The method as claimed in claim 11, wherein each battery pack includes:
a battery module including at least one battery cell,
a battery management system (BMS) to receive state information of the battery module and to transmit the state information and the identifier of the battery pack, in which the BMS is included, to another battery pack through the CAN communication line, and
exchanging of the identifiers of the battery packs is performed by the BMSs of the battery packs.

16. The method as claimed in claim 15, wherein determining the master battery pack and the slave battery packs includes:
comparing, by the BMS of each battery pack, the identifier of the battery pack, in which the BMS is included, with the identifier of another battery pack to determine whether the battery pack, in which the BMS is included, is a master battery pack or a slave battery pack.

17. The method as claimed in claim 11, wherein controlling the master battery pack and the slave battery packs includes:
transmitting state information of the slave battery packs from the slave battery packs to the master battery pack, and
transmitting the state information of the slave battery packs and state information of the master battery pack from the master battery pack to the controller.

18. The method as claimed in claim 17, wherein the state information includes at least one of voltages, currents, temperatures, or SOCs of the battery packs.

19. The method as claimed in claim 11, wherein controlling the master battery pack and the slave battery packs includes:
establishing communications between a controller and the battery packs using CAN IDs, wherein a CAN ID used for communication between the controller and the master battery pack is different from CAN IDs used for communication between the master battery pack and the slave battery packs.
